(19) United States
(12) Patent Application Publication
(10) Pub. No.: US 2024/0021818 A1
(43) Pub. Date: Jan. 18, 2024

(54) LITHIUM MANGANESE IRON PHOSPHATE-BASED ELECTRODE FOR AN ELECTROCHEMICAL LITHIUM ION CELL

(71) Applicant: SAFT, Levallois-Perret (FR)

(72) Inventors: Michelle BAUDRY, Eysines (FR); Cècile TESSIER, Bruges (FR); Lucille GAL, Eysines (FR)

(73) Assignee: SAFT, Levallois-Perret (FR)

(21) Appl. No.: 18/033,738

(22) PCT Filed: Oct. 26, 2021
(86) PCT No.: PCT/EP2021/079736

§ 371 Date: Apr. 25, 2023

(30) Foreign Application Priority Data
Oct. 26, 2020 (FR) 2010962

(51) Int. Cl. H01M 4/58; H01M 4/131; H01M 4/66; H01M 10/0525

(52) U.S. Cl. CPC H01M 4/5825; H01M 4/131; H01M 4/661; H01M 10/0525; H01M 2004/021

(57) ABSTRACT

The present invention relates to an electrode comprising a current collector formed by a metal strip which is coated on at least one of the faces thereof with a composition of electrochemically active materials, the composition comprising at least one lithium manganese iron phosphate having the following formula: LiₓMn_{1-y-z}Fe_{y}M_{z}PO₄, where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; the current collector having undergone chemical pickling of at least one of the faces thereof.

### TECHNICAL FIELD OF THE INVENTION

The technical field of the present invention is that of positive electrodes (cathodes) intended for use in an electrochemical cell, preferably of the lithium-ion type, said positive electrodes comprising a current collector which is coated on at least one of the faces thereof by a composition of electrochemically active materials, at least one of which is based on a lithium manganese iron phosphate.

### CONTEXT OF THE INVENTION

An electrochemical cell, also designated by the term “cell” in the following, comprises an electrochemical bundle consisting of an alternation of cathodes and anodes surrounding a separator impregnated with electrolyte. Each cathode and anode consists of a metal current collector supporting on at least one of the faces thereof at least one active material and generally a binder and an electronically conductive material.

The lithium oxides of transition metals are known as cathodic active material which can be used in rechargeable lithium electrochemical generators (secondary electrochemical cells). In the positive electrode, lithium oxides of transition metals of general formula LiMO₂ are most often used as active material, where M represents at least one transition metal, such as Mn, Ni, Co, Al or a mixture thereof These active materials allow to obtain high performance, in particular in terms of reversible cycling capacity and service life. The lithium oxides of transition metals of formula LiMO₂, where M represents the elements nickel, cobalt and aluminum have a good cycle life but have the disadvantage of being on the one hand expensive and on the other hand unstable at high temperature. The high temperature instability of this type of material can constitute a risk for the user of the electrochemical generator when the latter operates outside its nominal conditions.

Other types of active materials of lower cost and having better thermal stability have been studied, including lithium phosphates of at least one transition metal, in particular compounds based on LiFePO₄. However, the use of these compounds comes up against their low capacity, their low electronic conductivity, and the fact that LiFePO₄ and FePO₄ are poor electronic conductors. It is therefore necessary to add a high proportion of an electronically conductive material to the electrode, which penalizes its performance, in particular its cycling characteristics.

The lithium iron phosphates of formula LiₓFe_{1-y}M_{y}PO₄ with 0.8≤x≤1.2; 0≤y<0.5 are known as cathode active material of lithium-ion cells. In these phosphates, the iron element is the majority transition metal. It can be partially substituted by one or more elements symbolized by the symbol M. During the manufacture of the cathode, the lithium iron phosphate in powder form is typically mixed with a binder which is generally polyvinylidene fluoride (PVDF) and with an electronically conductive compound. The role of the binder is to ensure the cohesion of the particles of lithium iron phosphates between each other as well as their adhesion to the current collector of the electrode.

The lithium manganese iron phosphates of formula LiₓMn_{1-y-z}Fe_{y}M_{z}PO₄ (LMFP) with 0.8≤x≤1.2; 1-y-z>0.5; 0.05≤y<0.5 and 0≤z≤0.2 are also known for their use as a cathodic active material of lithium-ion cells. These phosphates contain manganese, iron and one or more substituent elements symbolized by the symbol M. Manganese is the majority transition metal. Iron is in a minority. Lithium manganese iron phosphates have a higher operating voltage than lithium iron phosphates. Indeed, lithium iron phosphates have a plateau voltage of 3.45V versus Li⁺/Li. Lithium manganese iron phosphates can operate at a higher voltage, due to the existence of a voltage plateau at 4.1 V versus Li⁺/Li corresponding to the Mn²⁺/Mn³⁺ couple.

However, active materials of the LMFP type have a very high specific surface. Due to this high specific surface, the electrode comprising the LMFP material alone generally has a high porosity, typically 40% or more. The active material composition includes the electrochemically active material(s), the binder(s) and the electronically conductive compound(s). This porosity value range of 40% or more typically corresponds to a composition of active material comprising from 80 to 90% of active material of LMFP type. This high porosity makes it difficult to produce electrodes for high energy density electrochemical cells. In addition to its porosity, an electrode can be defined by its basis weight. The basis weight of an electrode corresponds to the mass of the composition of active materials deposited per unit area on at least one face of the current collector. A high basis weight of electrode is desirable if it is sought to obtain an “energy” type cell, that is to say a cell for which the amount of energy that it can deliver is preferred, without necessarily imposing minimum requirement in terms of the power it can deliver. An electrode comprising an active material based on LMFP which has a high basis weight is therefore sought. To these two objectives which are the search for an electrode having low porosity and the search for an electrode having a high basis weight, a third objective is added which is to obtain an electrode which retains its flexibility. Indeed, it is generally observed that the flexibility of an electrode decreases when its porosity decreases and/or when its basis weight increases. A good flexibility of the electrode is necessary to guarantee a regularity of the manufacturing process of the cell on an industrial scale.

There is therefore a need to provide a lithium manganese iron phosphate (LMFP)-based positive electrode which would have a lower porosity, a higher basis weight while retaining good flexibility.

### SUMMARY OF THE INVENTION

The first object of the invention is an electrode comprising a current collector formed by a metal strip which is coated on at least one of the faces thereof with a composition of electrochemically active materials, said composition comprising at least one lithium manganese iron phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2;

said current collector having undergone chemical pickling of at least one of the faces thereof.

According to one embodiment, said composition of electrochemically active materials

comprises a mixture comprising:
from 90% to 99% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
from 1 to 10% by weight of a lithium oxide of transition metals relative to the total weight of all the electrochemically active materials of the composition, said lithium oxide corresponding to one of the following formulas:
i) Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof;
ii) Li_{w}(NiₓMn_{y}Co_{z}Mₜ)O₂ where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

According to another embodiment, said composition of electrochemically active materials comprises a mixture comprising:
approximately 50% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1 -y-z<1; 0.05≤y≤0.5 and 0≤z≤0.2; and
approximately 50% by weight of a lithium oxide of transition metals relative to the total weight of all the electrochemically active materials of the composition, said lithium oxide having one of the following formulas:
i) Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof;
ii) Li_{w}(NiₓMn_{y}Co_{z}Mₜ)O₂ where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

According to one embodiment, said composition of active materials comprises a mixture comprising:
from 90% to 99% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
from 1 to 10% by weight of a lithium oxide of transition metals relative to the total weight of all the electrochemically active materials of the composition, said lithium oxide having the following formula: Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof

According to one embodiment, the current collector is a strip made of aluminum or an aluminum alloy.

According to another embodiment, the current collector is coated on both faces with said composition of electrochemically active materials.

According to one embodiment, the current collector has a hollowing rate of less than 10%.

According to one embodiment, the current collector after chemical pickling has a thickness comprised between 5 μm and 35 μm.

According to one embodiment, said composition of active materials has a basis weight comprised between 8 mg/cm²/face and 25 mg/cm²/face.

According to one embodiment, the electrode has a porosity of less than 40%.

According to one embodiment, the current collector is solid.

According to another embodiment, the current collector has pores whose diameter is less than 0.3 mm, preferably less than or equal to 100 μm, or less than or equal to 50 μm, or less than or equal to 20 μm.

According to one embodiment, the current collector does not have a through hole.

A second object of the invention is an electrochemical cell comprising at least one electrode as defined above.

According to one embodiment, the electrochemical cell is of the lithium-ion type. The applicant has discovered, surprisingly, that the use of a current collector formed by a metal strip having undergone chemical pickling allows to overcome the disadvantages encountered when using an active material composition of the LMFP type. Indeed, it was found that the use of such a current collector which is coated with a composition of active material of LMFP type, allowed to obtain an electrode having a high basis weight and a lower porosity, while retaining its flexibility.

It was also discovered that the electrode according to the invention had a reduced polarization. The electrode according to the invention has improved chargeability by inducing, at the end of charging, a reduction in the charging time at constant voltage (floating time) during which it remains exposed to a high potential, for example at least 4.3 V versus a lithium metal reference.

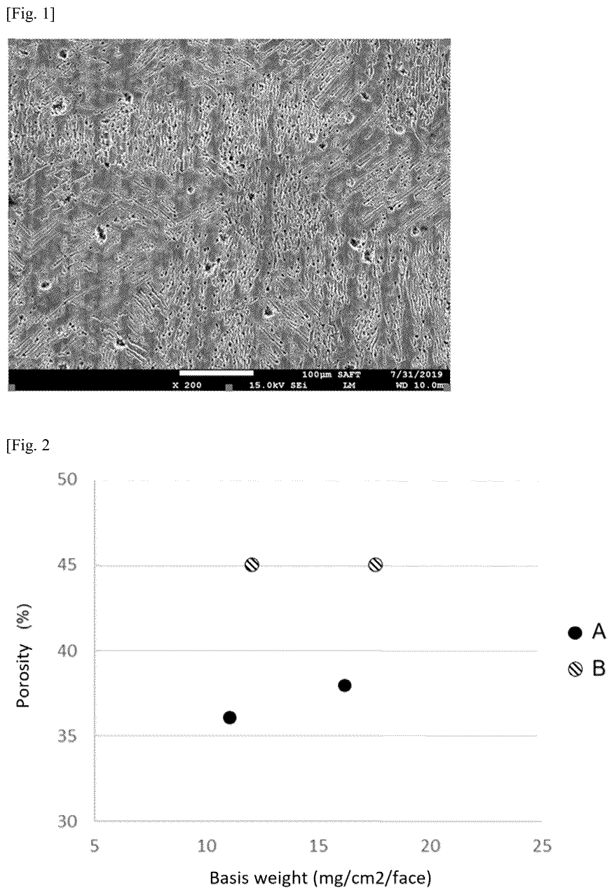

### BRIEF DESCRIPTION OF THE FIGURES

[FIG. 1] shows a scanning electron microscope (SEM) view of the surface of a current collector after pickling.

[FIG. 2] is a graph comparing the porosity (expressed in % on the ordinate axis) of an

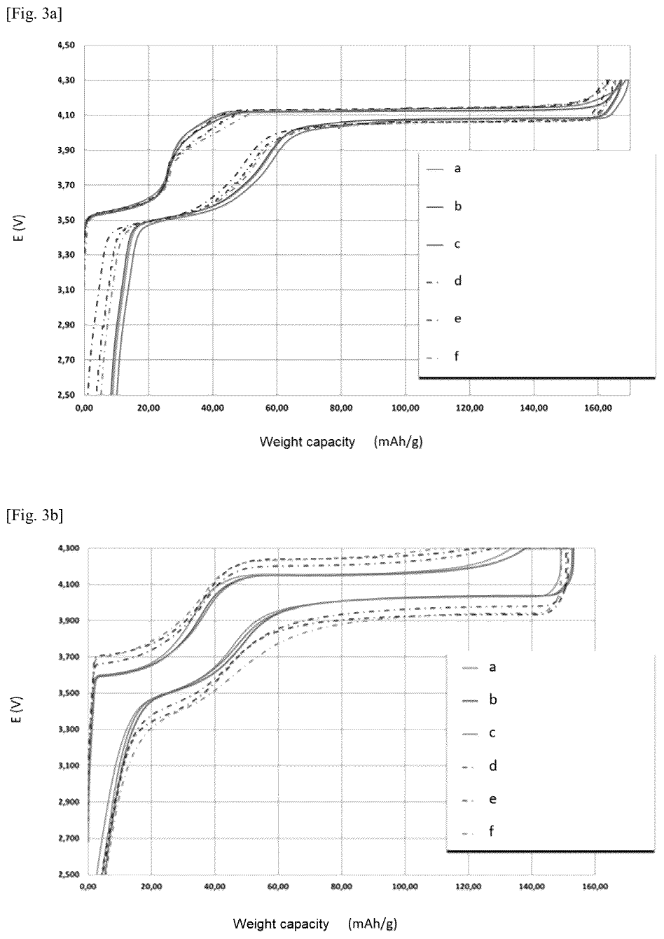

electrode according to the invention (comprising a current collector having undergone chemical pickling (points A)) with that of a reference electrode (points B) whose current collector has not undergone chemical pickling as a function of the amount of the composition of active materials (basis weight expressed in mg/cm²/face on the abscissa axis). In both cases, the composition of active materials comprises a mixture of active materials of LMFP and NCA type.

[FIG. 3a] is a graph allowing to compare the evolution of the voltage of an electrode according to the invention (solid line curves a, b, c) and of a reference electrode (dotted line curves d, e, f) during the first cycle. This first cycle comprises a charge consisting of a first step of charging at a constant current of C/20 until a voltage of 4.3 V is reached and a second step at a constant voltage of 4.3 V. The second step of charging takes place at a constant voltage of 4.3 V as long as the measured charging current is greater than a threshold value. This threshold value is determined according to the capacity of the electrode which can be for example C/100. When the charging current becomes lower than the threshold value, a discharge is carried out until a cut-off voltage of 2.5 V is reached. The two electrodes comprise as active materials a mixture of active materials of the LMFP and NCA type.

[FIG. 3b] is a graph allowing to compare the evolution of the voltage of an electrode

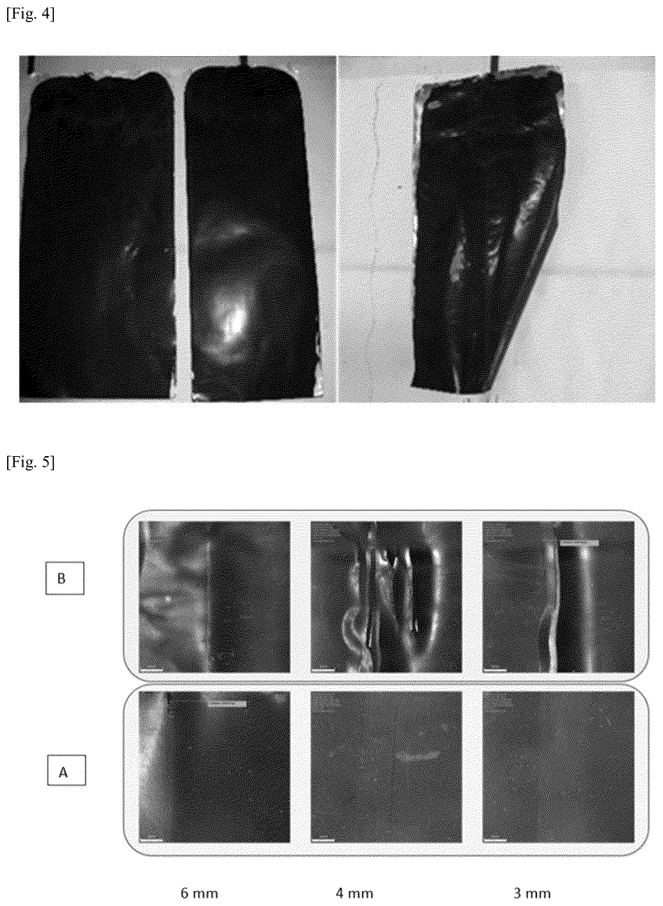

according to the invention (solid line curves a, b, c) and of a reference electrode (dotted line curves d, e, f) during the third cycling cycle at room temperature. This third cycle comprises a charge consisting of a first step of charging at a constant current of C/5 until a voltage of 4.3 V is reached and a second step at a constant voltage of 4.3 V. The second step of charging takes place at a constant voltage of 4.3 V as long as the measured charging current is greater than a threshold value. This threshold value is determined according to the capacity of the electrode which can be for example C/100. When the charging current becomes lower than the threshold value, a discharge is carried out until a cut-off voltage of 2.5 V is reached. The two electrodes comprise as active materials a mixture of active materials of the LMFP and NCA type.

[FIG. 4] is a photograph comparing the appearance of an electrode according to the invention with that of a reference electrode:
on the left, an electrode according to the invention comprising a current collector having undergone chemical pickling, which current collector is coated on both faces with a composition of active materials comprising a mixture of active materials of the LMFP and NCA type. On each of the two faces of the current collector, the basis weight is 15.5 mg/cm².
on the right, a reference electrode comprising a current collector which has not undergone chemical pickling, which collector is also coated on both faces with a composition of active materials comprising a mixture of active materials of the LMFP and NCA type. On each of the two faces of the current collector, the basis weight is 12 mg/cm².

[FIG. 5] is a series of photographs taken after carrying out a bending test consisting in bending the electrode around an axis of increasingly small diameter (6, 4 and 3 mm). This test is carried out on an electrode according to the invention (A) and on a reference electrode (B).

### DESCRIPTION OF EMBODIMENTS OF THE INVENTION

The first object of the invention is an electrode comprising a current collector formed by a metal strip which is coated on at least one of the faces thereof with a composition of electrochemically active materials, said composition comprising at least one lithium manganese iron phosphate having the following formula:
LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2;
said current collector having undergone chemical pickling of at least one of the faces thereof.

### Current Collector

The current collector is a metal strip which may be made of aluminum or of an alloy mainly comprising aluminum. Advantageously, the metal strip is made of aluminum.

There are different methods for pickling a material known from the prior art. Indeed, a material can be pickled chemically, mechanically, thermally or electrochemically.

In order to respond to the problem that the invention proposes to solve, namely to reduce the porosity, increase the basis weight while maintaining the flexibility of the electrode, the applicant has discovered that chemical pickling was the most suitable for the invention and allowed to get better results.

The current collector used in the present invention has previously undergone a chemical pickling step. It is preferably an acid chemical pickling. For example by a solution of hydrochloric acid, sulfuric acid or ferric chloride.

According to one embodiment, the current collector can be chemically pickled on its two faces.

The current collector after having undergone chemical pickling, may have a thickness less than or equal to 100 μm, preferably less than or equal to 50 μm, and more advantageously ranging from 5 μm to 35 μm.

According to one embodiment of the invention, the current collector can be a solid current collector. The term “solid” means a non-porous current collector, that is to say devoid of closed pores or open pores.

According to another embodiment, the current collector can be porous. Preferably, the pores of the current collector are not through holes. Pore depth measurement can be performed using a confocal microscope. According to one embodiment, the depth of the pores of the current collector can be comprised between 5 and 10 μm.

According to another embodiment, the current collector may have pores whose diameter is less than or equal to 0.3 mm, preferably less than or equal to 100 μm, or less than or equal to 50 μm, or less than or equal to 20 μm.

According to yet another embodiment, the current collector may have pores whose diameter is less than or equal to 0.3 mm, which pores are not through holes.

According to one embodiment, the current collector can have a hollowing rate less than or equal to 10%, that is to say a reduction in the mass after pickling of 10% or less.

The hollowing rate is determined by comparing the mass of a current collector according to the invention (having undergone chemical pickling) with the mass of a current collector before pickling.

The current collector can be coated on both faces with said composition of electrochemically active materials.

### Composition of Electrochemically Active Materials

The term “composition of electrochemically active materials” means the composition comprising all the compounds which cover the current collector on at least one of the faces thereof. Generally this composition comprises:
an electrochemically active material or a mixture of electrochemically active materials;
one or more binders; and
one or more electronically conductive materials, such as carbon.

Said composition of electrochemically active materials comprises at least one lithium manganese iron phosphate (LMFP) having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2. According to one embodiment, 0.7≤1-y-z≤0.9. According to another embodiment, 0.7≤1-y-z≤0.85. Mention may be made, for example, of LiMn_{0.8}Fe_{0.2}PO₄, LiMn_{0.7}Fe_{0.3}PO₄, LiMn_{2/3}Fe_{1/3}PO₄ and LiMn_{0.5}Fe_{0.5}PO₄.

According to one embodiment, the composition of electrochemically active materials may comprise, as sole active material, one or more active materials of the LMFP type as described above.

According to another embodiment, the composition of electrochemically active materials may comprise a mixture comprising:
from 90% to 99% by weight of lithium manganese iron phosphate (LMFP) relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
from 1 to 10% by weight of a lithium oxide of transition metals relative to the total weight of all the electrochemically active materials of the composition, said lithium oxide corresponding to one of the following formulas:
   i) Li_{w}(NiₓCo_{y}Al_{z}Mₜ)O₂ (active material of NCA type), where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof;
   ii) Li_{w}(NiₓMn_{y}Co_{z}Mₜ)O₂ (active material of NMC type) where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

According to another embodiment, the composition of electrochemically active materials may comprise a mixture comprising:
from 80% to 99% by weight of lithium manganese iron phosphate (LMFP) relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
from 1 to 20% by weight of a lithium oxide of transition metals relative to the total weight of all the electrochemically active materials of the composition, said lithium oxide corresponding to one of the following formulas:
   i) Li_{w}(NiₓCo_{y}Al_{z}Mₜ)O₂ (active material of NCA type), where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof
   ii) Li_{w}(NiₓMn_{y}Co_{z}Mₜ)O₂ (active material of NMC type) where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

The active material of NMC type can be of formula Li_{w}(NiₓMn_{y}Co_{z}Mₜ)O₂ (NMC) where 0.9≤w≤1.1; x>0; y>0; z>0; t≥0; M being selected from the group consisting of Al, B, Mg and mixtures thereof. Preferably, M is Al and t≤0.05. The predominant transition element is preferably nickel, that is to say x≥0.5, even more preferably x≥0.6. A high amount of nickel in the lithium nickel oxide is preferable because it provides high energy to the lithium nickel oxide. Preferably x≤0.9. The active material of NMC type can correspond to the formula Li_{w}(NiₓMn_{y}Co_{z}Mₜ)O₂ where 0.9≤w≤1.1; x≥0.6; y≥0.1; z≥0.1; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof. Mention may be made, for example, of: LiNi_{0.6}Mn_{0.2}Co_{0.2}O₂ and LiNi_{0.8}Mn_{0.1}Co_{0.1}O₂.

According to a particular embodiment, the composition of electrochemically active materials may comprise a mixture comprising:
from 90% to 99% by weight of lithium manganese iron phosphate relative to the total weight of all the electrochemically active materials of the composition, said lithium phosphate (LMFP) having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture; 0.8≤x≤1.2; 0.5≤1-y-z<1; 0.05≤y≤0.5 and 0≤z≤0.2; and
from 1 to 10% by weight of a lithium oxide of transition metals relative to the total weight of all the electrochemically active materials of the composition, said lithium oxide having the following formula: Li_{w}(NiₓCo_{y}Al_{z}Mₜ)O₂ (NCA), where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof.

The active material of NCA type can be of formula Li_{w}(NiₓCo_{y}Al_{z}Mₜ)O₂ where 0.9≤w≤1.1; x>0; y>0; z>0; t≥0; M being selected from the group consisting of B, Mg and mixtures thereof. Preferably, 0.70≤x≤0.95; 0.03≤y≤0.25; z≤0.1; t=0 and x+y+z+t=1. More preferably 0.75≤x≤0.85; 0.10≤y≤0.20. For example, mention may be made of: LiNi_{0.8}Co_{0.15}Al_{0.05}O₂.

According to one embodiment, the composition of electrochemically active materials comprises a mixture comprising:
from 95 to 50% or from 90 to 50% or from 85 to 50% or from 80 to 60% or from 70 to 60% by weight of lithium manganese iron phosphate (LMFP) relative to the total weight of all the electrochemically active materials of the composition;
from 5 to 50% or from 10 to 50% or 15 to 50% or from 20 to 40% or from 30 to 40% by weight of active materials of NCA or NMC type as described above, relative to the total weight of all the electrochemically active materials of the composition.

More advantageously, the composition of electrochemically active materials comprises a mixture consisting of:
approximately 90% by weight of active materials of LMFP type as described above, relative to the total weight of all the active materials of the composition; and
approximately 10% by weight of active materials of NCA type as described above relative to the total weight of all the active materials of the composition.

According to one embodiment, said composition of electrochemically active materials may have a basis weight comprised between 3 and 50 mg/cm²/face or comprised between 8 and 25 mg/cm²/face, or between 10 and 20 mg/cm²/face.

### The Electrode

Generally, an electrode is manufactured by preparing an ink comprising one or more active materials mixed with one or more binders, with one or more electronically conductive materials and with a solvent. This ink is then coated on at least one of the faces of a current collector. The solvent is evaporated. The thickness of the composition coated on at least one of the faces of the current collector is adjusted by passing the electrode between two rollers exerting pressure on the surface of the electrode (calendering step).

The porosity of the electrode is defined as the percentage of the pore volume relative to the geometric volume of the electrode. The pore volume encompasses the void volume between the particles of the compounds in the layer deposited on the electrode current collector and the pore volume within the compound particles in the layer deposited on the current collector of the electrode. The pores within the particles include accessible (open) pores and inaccessible (closed) pores.

The porosity of the electrode can be obtained from the following two methods:
In a first method, the mercury technique is used to determine the pore volume. The geometric volume of the electrode is obtained by multiplying the thickness of the layer deposited on the current collector by the surface coated by the layer. The porosity is obtained by calculating the ratio between the pore volume and the geometric volume of the electrode.
In a second method, the theoretical density dₜₕₑₒ is calculated from the density of each compound of the coated layer on the current collector. The apparent density dₐₚₚ is calculated by knowing the mass and the geometric volume of the coated layer on the current collector.
The relation that connects the porosity to the theoretical density and to the apparent density is the following: Porosity=1−(dₐₚₚ/dₜₕₑₒ).

The porosity of a cathode containing lithium manganese iron phosphate as sole active material is generally at least 40%.

According to one embodiment, the electrode according to the invention may have a porosity of less than or equal to 40%, or greater than or equal to 30%, preferably equal to approximately 35%, as well as a basis weight comprised between 3 and 50 mg/cm²/face or comprised between 8 and 25 mg/cm²/face, or comprised between 10 and 20 mg/cm²/face.

Thanks to the reduction in porosity, the electrode according to the invention contains a higher amount of active material per unit volume.

### Electrochemical Cell

A second object of the invention is an electrochemical cell comprising at least one electrode as defined above.

The electrochemical cell can be of the lithium-ion type.

The electrochemical cell can comprise as positive electrode (cathode) an electrode as defined above.

### EXAMPLES

In order to evaluate the electrochemical and mechanical properties of an electrode according to the invention, comparative tests were carried out. In these tests, the reference electrode has a current collector that has not undergone chemical pickling.

FIG. 2 is a graph comparing the porosity (expressed in % on the ordinate axis) of an electrode according to the invention (comprising a current collector having undergone chemical pickling (points A)) with that of a reference electrode (points B) whose current collector has not undergone chemical pickling as a function of the amount of the composition of active materials (basis weight expressed in mg/cm²/face on the abscissa axis. In both cases, the active material used is a mixture of active materials comprising 90% by weight of LMFP and 10% by weight of NCA.

It can be seen that the reference electrode has a porosity of 45%, while the porosity of the electrode according to the invention is comprised between 35 and 38%. Thus, the electrode of the invention has a lower porosity than that of the reference electrode while maintaining a similar basis weight. It follows that the same amount of composition of active materials can be deposited over a smaller thickness. Moreover, it is observed that the electrode according to the invention is flexible while the reference electrode is rigid.

FIG. 4 allows to highlight certain mechanical properties of the electrode of the invention. For this purpose, the following electrodes were tested:
A reference electrode (photograph on the right) of dimensions 10 cm×21 cm and of which the thickness of the strip is 20 μm.
An electrode according to the invention (photograph on the left) of dimensions of 10 cm×21 cm and of which the thickness of the strip is 30 μm.

These two electrodes were placed beforehand in a ventilated drying cabinet of the brand BINDER, model FDL115 for 10 minutes at 110° C., then have undergone calendering at 0.4 m·s⁻¹ at ambient temperature. The photographs were taken after drying and calendering.

It can be seen that the reference electrode (photograph on the right) has significant deformation of its lower right corner, due to internal mechanical stresses, where the electrode according to the invention (photograph on the left) does not have any. Consequently, the electrode according to the invention has greater flexibility compared to the reference electrode. Therefore, with a basis weight greater than that of the reference electrode and with a reduced thickness, the electrode according to the invention has good mechanical properties. Thanks to these properties, the electrode can be used in an electrochemical cell without increasing its rigidity. Indeed, the current collector of the invention allows to attenuate the mechanical stresses of calendering and therefore to maintain optimum flexibility.

In addition, it has been found that the chemical pickling applied to the current collector causes asperities which help to further retain the composition of active materials during the spiraling of the electrode, which is not the case for the reference electrode where a loss of composition of active materials is observed. Obtaining good flexibility of the electrode allows to improve the regularity of the industrial process for manufacturing the electrochemical cell by reducing the risks of tearing the electrode.

In order to further demonstrate the flexibility of the electrode according to the invention, an additional bending test was carried out using a Mandrel Bending Tester EQ-MBT-12-LD apparatus, sold by the company MTI. The results of this test are presented in FIG. 5. This bending test consists of bending the electrode around an axis of increasingly small diameter (6; 4 and 3 mm) and visually observing the consequences of this bending. Two different electrodes have undergone this test: an electrode according to the invention (A) and a reference electrode (B). Once the bends have been made, the electrodes are unfolded and photographed. It can be observed that the non-flexible zones appear on the photograph as white marks. This test shows that the reference electrode is clearly more marked by the folds than the electrode of the invention. The electrodes comprising the current collector according to the invention are therefore more flexible than the reference electrode.

Button format electrochemical cells have been manufactured. The anode is made of lithium. The cathode comprises a composition of active materials comprising a mixture of LMFP and NCA. This mixture comprises 10% by weight of active material of NCA type with formula LiNi_{0.8}Co_{0.15}Al_{0.05}O₂ and 90% by weight of active material of LMFP type with formula LiMn_{0.8}Fe_{0.2}PO₄. The cathode of the cells according to the invention comprises a current collector which is an aluminum strip which has undergone chemical pickling. The cathode of the reference cells is an aluminum strip that has not undergone chemical pickling. The electrolyte comprises a mixture of cyclic carbonates and linear carbonates to which LiPF₆ was added at a concentration of 1 mol·L⁻¹. The separator inserted between the anode and the cathode is of the polyolefin type.

The cells were subjected to a first cycle starting with a charge consisting of a first step at a constant current of C/20 until a voltage of 4.3 V is reached and a second step at a constant voltage of 4.3 V. The second step of charging takes place at a constant voltage of 4.3 V as long as the measured charging current is greater than a threshold value. This threshold value is determined according to the capacity of the electrode, for example C/100. When the charging current becomes lower than the threshold value, a discharge is performed until a cut-off voltage of 2.5 V is reached.

The third cycle of cycling begins with a charge consisting of a first step of charging at a constant current of C/5 until a voltage of 4.3 V is reached and a second step at a constant voltage of 4.3 V. The second step of charging takes place at a constant voltage of 4.3 V as long as the measured charging current is greater than a threshold value. This threshold value is determined according to the capacity of the electrode, for example C/100. When the charging current becomes lower than the threshold value, a discharge is performed until a cut-off voltage of 2.5 V is reached.

FIGS. 3a and 3b show that in cycle 1 or 3 the electrode according to the invention (solid line curves a, b, c) allows on the one hand to reduce the polarization of the cell. Indeed, the difference between the charge voltage and the discharge voltage of the cell for a given state of charge of the cell is lower for the cells according to the invention than for the reference cells (dotted line curves d, e, f). This difference is more marked in the 3^{rd} cycle carried out at a rate of C/5 than in the 1^{st} cycle carried out at a rate of C/20. On the other hand, it is noted that the invention allows to reduce the time during which the electrode is exposed to a high potential, in this case 4.3 V.

Consequently, the electrode according to the invention allows to limit the oxidation of the electrolyte, the latter remaining exposed for less time to a high potential. The invention also allows to reduce the degradation of the lamellar oxide NCA which is subjected to a high potential for less time.

1. An electrode comprising a current collector formed by a metal strip which is coated on at least one of the faces thereof with a composition of electrochemically active materials, said composition comprising at least one lithium manganese iron phosphate having the following formula:
LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2;
said current collector having undergone chemical pickling of at least one of the faces thereof.

2. The electrode according to claim 1, wherein said composition of electrochemically active materials comprises a mixture comprising:
from 90% to 99% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
from 1 to 10% by weight of a lithium oxide of transition metals relative to the total weight of all the electrochemically active materials of the composition, said lithium oxide corresponding to one of the following formulas:
i) Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof;
ii) Li_{w}(NiₓMn_{y}Co_{z}Mₜ)O₂ where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

3. The electrode according to claim 1, wherein said composition of electrochemically active materials comprises a mixture comprising:
approximately 50% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0≤z≤0.2; and
approximately 50% by weight of a lithium oxide of transition metals relative to the total weight of all the electrochemically active materials of the composition, said lithium oxide corresponding to one of the following formulas:
i) Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof;
ii) Li_{w}(NiₓMn_{y}Co_{z}Mₜ)O₂ where 0.9≤w≤1.1; x>0; y>0; z>0; t≥0; M being selected from the group consisting of Al, B, Mg, Si, Ca, Ti, V, Cr, Fe, Cu, Zn, Y, Zr, Nb, W, Mo, Sr, Ce, Ga, Ta and mixtures thereof.

4. The electrode according to claim 2, wherein said composition of active materials comprises a mixture comprising:
from 90% to 99% by weight of lithium manganese iron phosphate relative to the total weight of all the electrochemically active materials of the composition, said lithium phosphate having the following formula: LiₓMn_{1-y-z}Fe_{y}M_{z}PO₄ where M is selected from the group consisting of B, Mg, Al, Si, Ca, Ti, V, Cr, Co, Ni, Cu, Zn, Y, Zr, Nb and Mo, alone or in a mixture, with 0.8≤x≤1.2; 0.5≤1-y-z<1; 0.05≤y≤0.5 and 0<z<0.2; and
from 1 to 10% by weight of a lithium oxide of transition metals relative to the total weight of all the electrochemically active materials of the composition, said lithium oxide having the following formula:
Li_{w}(NiₓCo_{y}Al_{z}Mₜ)O₂, where 0.9≤w≤1.1; x>0; y>0; z>0; t≥0; M being selected from the group consisting of B, Mg, Si, Ca, Ti, V, Cr, Mn, Fe, Cu, Zn, Y, Zr, Nb, W, Mo, Sr, Ce, Ga, Ta and mixtures thereof.

5. The electrode according to claim 1, wherein the current collector is a strip made of aluminum or an aluminum alloy.

6. The electrode according to claim 1, wherein the current collector is coated on both faces with said composition of electrochemically active materials.

7. The electrode according to claim 1, wherein the current collector has a hollowing rate of less than 10%.

8. The electrode according to claim 1, wherein the current collector after chemical pickling has a thickness comprised between 5 μm and 35 μm.

9. The electrode according to claim 1, wherein said composition of active materials has a basis weight comprised between 8 mg/cm²/face and 25 mg/cm²/face.

10. The electrode according to claim 1, wherein the electrode has a porosity of less than 40%.

11. The electrode according to claim 1, wherein the current collector is solid.

12. The electrode according to claim 1, wherein the current collector has pores whose diameter is less than 0.3 mm, preferably less than or equal to 100 μm, or less than or equal to 50 μm, or less than or equal to 20 μm.

13. The electrode according to claim 1, wherein the current collector does not have a through hole.

14. An electrochemical cell comprising at least one electrode as defined according to claim 1.

15. The electrochemical cell according to claim 14 of the lithium-ion type.
